(19) United States
(12) Patent Application Publication
(10) Pub. No.: US 2009/0070801 A1
(43) Pub. Date: Mar. 12, 2009

(54) Automated Advertising Production Portal

(76) Inventors: Kyle M. Lake, Lexington, KY (US); Galen A. Rasche, San Antonio, TX (US)

Correspondence Address: Yury A. Perzov, 1323 Palm St., San Jose, CA, 95110, US

(21) Appl. No.: 11/852,333

(22) Filed: Sep. 10, 2007

(51) Int. Cl. H04N 7/10

(52) U.S. Cl. 725/32

(57) ABSTRACT

An automated advertisement production portal is described. The automated advertisement production portal automates the advertisement creation process. Users provide to the automated advertisement production portal video options and a script. The automated advertisement production portal generates a preview video or still image of selected options, contacts the contracted production company, and generates an estimated deadline. The automated advertisement production portal bills the customer. A finished advertisement video is uploaded to an automated advertisement production portal server where is can be downloaded. The customer is able to download various versions of the video for television broadcast or can be linked to by the customer in order to be embedded as an advertisement in a web site.

### FIELD OF THE INVENTION

The present invention relates to a method and apparatus for automation of design and creation of video advertisements with personalized production footage.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The widespread use of the internet has changed the face of several industries. Many processes have been made more efficient and automated, such as the delivery of personalized advertising through e-mail and tracking internet usage. One area that has lagged behind, however, is the creation and production of video advertising.

In creation of a video advertisement there are typically three participants; a client for whom the video advertisement is created, an advertisement agency that creates an idea and script for the advertisement, and a production company that films the advertisement. The three participants go through a series of steps to create a video advertisement using production footage.

Initially the client decides which media provider's viewer base will most likely be receptive to the advertisement. Media providers sell advertisement exposure to the client. Some examples of media providers are television stations, web news sites, magazines, billboards etc. In some cases media provides are also production companies. One instance of a production company that is also a media provider is a television station which has the capacity to record commercials.

Having established a target media provider, the client will then make a series of phone calls, emails or faxes to advertisement agencies requesting their services. The advertisement agency will in turn make follow up phone calls to the client to discuss the general idea of a script. An account manager at the advertisement agency will then open a file to track all the work.

Subsequently the advertisement agency writes a complete script, and sends a copy of the script to the client. The advertisement agency also sends a copy of the script to a production company. The production company will then prepare an estimate and send the estimate to the client. The estimate will include items such as the cost of chosen actors, cost of set design, equipment rental as well as production costs. The production company then explains the estimate to the client. The estimate is then deliberated upon and approved by the client. The delivery date of the advertisement is then negotiated between the client and the advertisement agency. When both negotiations of the advertisement delivery date and the estimate cost are complete between the advertisement agency and the client, the advertisement agency places a purchase order to the production company. The production company then begins filming the script. Once the advertisement is filmed, advertisement footage goes through final editing, checking and proofs by the production company. The production company delivers the advertisement footage to the advertisement agency. The production company also submits an invoice for the work to the advertisement agency. The advertisement agency checks the invoice against the purchase order and the estimate. The invoice is then entered in a finance system of the advertisement agency. An invoice is then submitted to the client by the advertisement agency.

Traditional approaches to production of video advertisements have a very high communication overhead. While recent advances in computers and data networks created a new set of communication channels as well as tools to deliver and create advertisements, the advances have done little to change the traditional approaches to video advertisement creation process. Recently, some production companies allowed customers to create advertisements by choosing media from a database and splicing/editing it together to form new advertisements. While this is an advance over the traditional method listed above, it only offers pre-shot footage for use in the advertisement. Moreover, even with the introduction of new software tools and delivery methods, production of completely personalized, actor-based video advertisements is very labor and time intensive, which makes video advertisement cost prohibitive for many small organizations. There is clearly a need to automate actor-based advertisement creation process as well as reduce the cost of advertisement delivery.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram of steps performed by an automated video production portal, according to an embodiment of the present invention;

FIG. 2 is a flow diagram of steps performed by the user of automated video production portal to specify video parameters, according to an embodiment of the present invention; and

FIG. 3 is a computer system according to an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

An automated advertisement production portal on-line (AAPPOL) is described. The AAPPOL allows customers to design their own advertisements and automates the communication and billing processes. Customers design their advertisement by selecting a number of video options provided by AAPPOL and entering a script. The AAPPOL also lets customers preview a still image of selected options. In another embodiment of the invention, a video preview may be created by AAPPOL. AAPPOL automatically contacts the affiliate production company, and generates an estimated completion time. As part of order processing, the AAPPOL collects customer payments. Once the advertisement is created by the production company, the production company delivers the advertisement to the AAPPOL. The AAPPOL in turn notifies the customer of the complete order and automatically delivers the finished product to the customer. The finished product can be embeddable code, video, instructions for use, etc. The AAPPOL provides storage or hosting services for finished advertisements. The customer is able to download various versions of the video for television broadcast or can be linked to by the customer in order to be embedded as an advertisement in a web site, electronic newsletter or electronic mail. The AAPPOL meets these seemingly conflicting needs, reducing the price of video creation while still allowing users to customize their videos. In particular, the AAPPOL offers the following benefits over current internet video production techniques: savings on advertising and marketing-related production expenditures, reduction in the time taken to implement, execute and administer video advertising by requiring no direct interaction with the production company. The web-based automated approach drives down the overall production costs, enabling small and medium sized business access to efficiently design, order and deliver advertisements.

### Automated Advertisement Production Portal

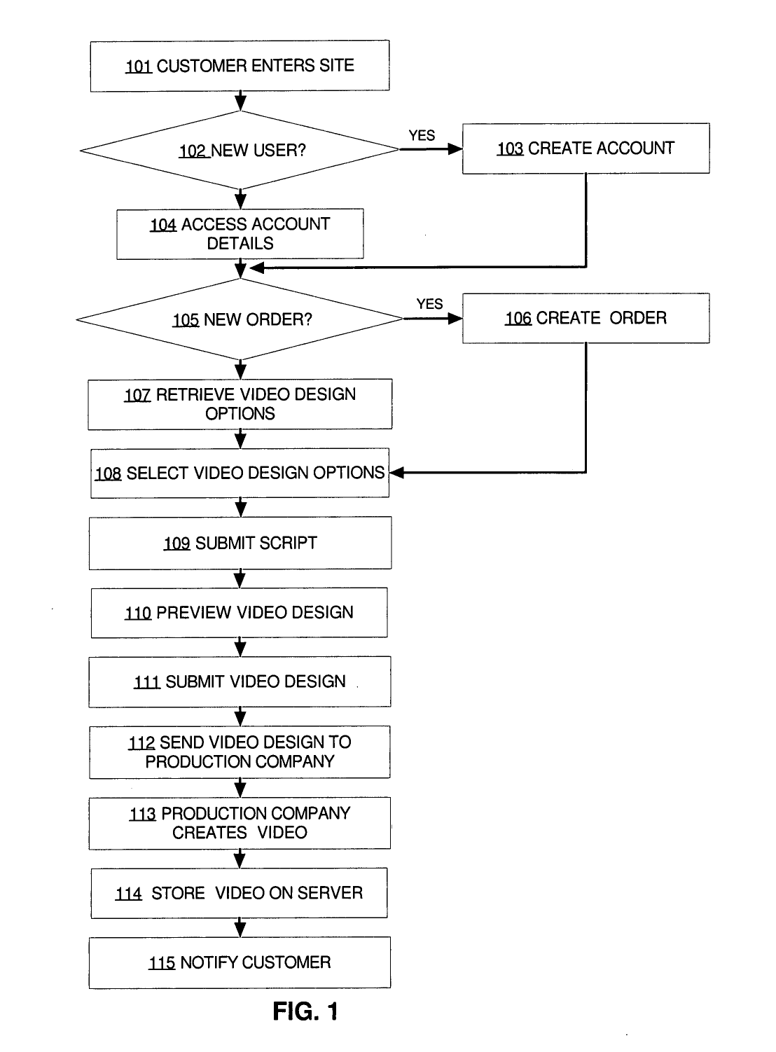

FIG. 1 is a flow chart of an automated video production process according to an embodiment of the current invention. A customer navigates to the AAPPOL web site in step 101. The AAPPOL web site determines whether the customer is a new user in step 102. If the customer is an existing user, he is prompted to enter a username and password. If the customer is a new user, the AAPPOL web site creates a user account in step 103. Whenever a user account is created, basic demographic information is collected such as username, password, company name (if applicable), e-mail address, mailing address, and phone number. An account creation confirmation email may be sent to the customer. If the customer already established an account, account details are accessed in step 104. Account details contain demographic information, payment history, past complete orders, as well as any video orders that may be in progress etc. In step 105 the AAPPOL prompts the customer to determine whether a new order needs to be created or work needs to continue on an existing order. If the customer chooses to work on an existing order the AAPPOL retrieves the video design options in step 107. Video design options are stored in a dedicated database. Otherwise a new order is created in step 106 and appropriate data structures are allocated in the video design database. The customer selects the video design options for a new order or modifies video options for an existing order in step 108. In step 109, the customer submits a script for the video into the AAPPOL. The AAPPOL generates a preview of the video design in step 110; the preview may be a still image or a video. At any point in the process between steps 101 and 110 the customer may save their work and log out of the AAPPOL site to resume the design process at a later time.

The customer then submits the video design to AAPPOL in step 111. As part of the submission process the AAPPOL checks the video design for errors and omissions such as no option can be left blank or incomplete. The customer must actively select every option. Such error checking helps to eliminate potential issues faced by a production company with customers who may come back and say “I didn't want a certain option”. AAPPOL then sends the video design to a production company in step 112. Communication to the production company can be in the form of an e-mail detailing the order. The production company then creates the video in step 113. The production company is responsible for filming, editing, encoding and formatting of the video. The production company can communicate the status of a video production to the AAPPOL site which in turn allows users to track the status of the video production. When the video is completed, the production company stores the video on the AAPPOL server in step 114. The AAPPOL then notifies the customer that the video is complete, as well as sends and posts embeddable code in step 115. The embeddable code can be a URL or HTML code for downloading or placing the video on the customer's web site. The AAPPOL tracks the number of times the video is downloaded or viewed. This tracking information can be used to bill the client for hosting and to provide popularity metrics of the video to the client.

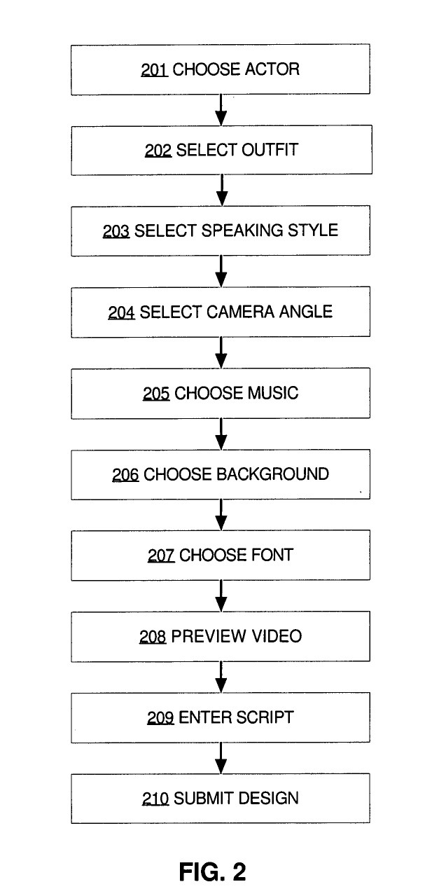

This design flow can be performed in order, or the user can click on any step to enter their design choices. Also for each stage of the video design process there exists an instructional video that the customer may access for help in completing the given stage of the process. The previous videos created for the customer as well as orders, options and settings are archived. Videos from all of the customers may also be stored in a searchable database directory. The customer may also “test drive” the video design steps without providing login information to AAPPOL, or without creating an order. Every step detailed in FIG. 2, 201 through 208 is accessible to users who do not have an account in AAPPOL.

### Video Design Interface

FIG. 2 shows the general flow of the video design as a series of steps:

A customer chooses an actor in step 201. The AAPPOL presents a customer with a page of pictures of available actors. Associated with every actor picture is an introductory video performed by the particular actor. The introductory videos can be viewed by the customer. Once a particular actor is selected, the customer selects an outfit for the actor in step 202. The actor's outfit can be selected from a number of styles included but not limited to, as business formal, business casual, sexy, or sport. For each dress style the customer can further customize each dress element, for example, for business formal style a suit, tie, pants, or a skirt can be specified. If business causal actor appearance is selected, the customer can specify khakis, pants, skirt, polo, dress shirt, tie or no tie. For sexy actor appearance, the customer selects tank-top, short skirt, bikini, fitness attire, muscle shirt, shorts. For sport actor appearance the customer may select a sports jersey, sweat-shirt, or ball-cap. Customers also have the option of selecting branded clothing for the actors to wear. Actor speaking style is selected by the customer in step 203. The customer is presented with a choice of speaking styles; energetic and warm, serious formal, humorous and light, or sexy and enticing. Energetic and warm style is quicker, enthusiastic, the actor tends to smile and use more hand gestures. A serious and formal speaking style is of slower cadence, the actor maintains direct eye contact and uses less gestures. A humorous and light speaking style by the actor is very personal, sarcastic, or witty. A sexy and enticing speaking style by the actor uses sultry tones, slower cadence and can be provocative. The customer can select a camera angle for the actor in step 204. The available camera angles are close up only which shows face and neck only, mid shot only which shows waist to head, full shot only which shows full body, head to toe, close up only mid shot only mix which shows first portion of the video mid-shot and second portion in close-up, and close-up full shot mix which shows the first portion of video in full shot and second portion in close up. The customer chooses music for the advertisement in step 205. Music can range a number of styles; jazzy, salsa, lite rock, urban beat, club beat, classical or corporate. Every style of music has a number of short samples that a customer can preview and select.

The customer may select the background for the advertisement in step 206. The customer may select a solid color for the background or an animated background. The AAPPOL web site presents the customer with still shots of the animated backgrounds. The customer may then click on any of the still shots to look at the preview. The customer may also upload digital photographs or digital video to be used as the background.

The customer may select a font in step 207. The customer must specify three parameters, font, color, text transition style. The text transition style can have two categories with onto screen, and off screen. For onto screen, the customer may select from a number of options included but not limited to slide in, dissolve in, zoom in, stretch in, tumble in, or fly in. For “off screen” the following options are presented, slide out, fade out, zoom out, stretch out, tumble out, and fly out.

The customer can preview the selected options in step 208. The AAPPOL web site generates a still image of the chosen actor wearing the specified style of dress. The actor appears in front of the customer chosen background. If applicable, sample text is shown using specified font and color.

The AAPPOL automatically checks the options chosen by the customer for compatibility and in order to prevent improper video orders from being created. For example, if the customer does not select an actor, but chooses a particular dress style, AAPPOL will display an error message.

The customer enters the script in step 209. The AAPPOL web site presents the customer with a text input box. The text box can have an upper limit on the amount of characters that can be entered. The AAPPOL website may offer numerous script writing tips to help the customer develop an effective advertisement message. The customer may also select to have a professional writer review, or help write the script.

The customer submits the video design in step 210. Once a design is submitted the customer may not perform any changes to the specified advertisement design. The customer then pays online via credit card, electronic check, or some other means of electronic payment. The customer is given an estimate of availability date for the requested video based on availability of the chosen actor and current production load. An e-mail is automatically sent to the user to verify receipt of their order and to provide a tracking number for order and payment. The e-mail will also contain a quick summary of the selected video-design options.

### Hardware Overview

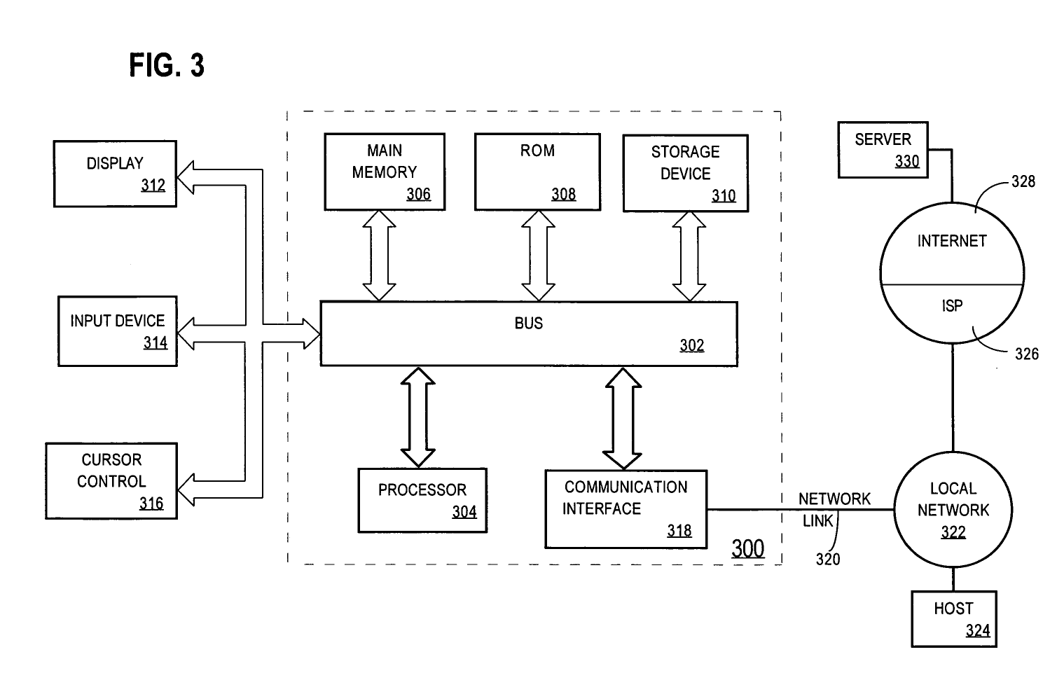

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer implemented method for automating production of a video comprising the steps of:
displaying a set of video options to a user in a web browser, wherein said set of video options are selectable by said user to customize production of said video;
in response to user input, generating a preview of said video, based in part on one or more selected video options from said set of video options;
generating a time estimate based in part on said one or more selected video options, wherein said time estimate indicates how much time before the video production is available to said user;
submitting said one or more selected video options to a video production company;
receiving said video from said video production company; and
storing said video.

2. The method of claim 1 wherein the step of displaying a set of video options to a user, includes retrieving said set of video options from a database, wherein said set of video options were previously specified by said user.

3. The method of claim 1 wherein the step of displaying a set of video options includes displaying said set of video options as radio buttons.

4. The method of claim 1 wherein said set of video options includes a camera angle, wherein said camera angle specifies the point of view from which said video will be recorded.

5. The method of claim 1 wherein said set of video options includes a style of music, wherein said style of music can be played at any point in said video.

6. The method of claim 1 wherein said set of video options includes selection of an actor, wherein said actor appears in said video.

7. The method of claim 6 wherein said set of video options includes a dress style, wherein said dress style specifies the dress style of said actor appearing in said video.

8. The method of claim 1 wherein the step of, in response to user input, generating a preview of said video, based in part on one or more selected video options from said set of video options still image video preview includes generating a preview of said video.

9. The method of claim 6 wherein the step of generating a time estimate based in part on said one or more selected video options is further based on availability of said actor.

8. The method of claim 1 including an additional step of providing hosting services, wherein hosting services include broadcasting the video to requesting users.

9. The method of claim 1 including an additional step of sending a notification to said user in response to storing said video.

10. The method of claim 1 wherein said notification includes embeddable code, wherein embeddable code allows said video to appear on said users web site.
